(19) United States
(12) Patent Application Publication
(10) Pub. No.: US 2017/0233071 A1
(43) Pub. Date: Aug. 17, 2017

(54) System and Method for Return-Home Command in Manual Flight Control

(71) Applicant: Skyyfish, LLC, Missoula, MT (US)

(72) Inventors: Orest Jacob Pilskalns, Missoula, MT (US); Colin Brian Heidtman, Missoula, MT (US)

(73) Assignee: SKYYFISH, LLC, Missoula, MT (US)

(21) Appl. No.: 15/433,967

(22) Filed: Feb. 15, 2017

Related U.S. Application Data
(60) Provisional application No. 62/295,413, filed on Feb. 15, 2016.

(51) Int. Cl. B64C 39/02; G07C 5/00; G08G 5/00; G05D 1/00; G05D 1/10

(52) U.S. Cl. CPC B64C 39/024; G05D 1/0011; G05D 1/0061; G05D 1/101; G08G 5/0039; G08G 5/0069; G08G 5/0056; G07C 5/004; B64C 2201/146; B64C 2201/141

(57) ABSTRACT

A return-to-home command for securing an unmanned aerial vehicle (UAV) from flying away. Flight plan updates that may be uploaded to the UAV can be interrupted at any time by uploading a modified flight plan or by instructing the UAV to pause while manual flight commands are given. The modifications to the original flight plan always ensure that a return-to-home step is present in the instructions on board the UAV, so that if the radio communications link between the remote controller and the UAV is lost, the UAV will fly home.

### CROSS REFERENCE TO RELATED APPLICATIONS

This application is related to and claims priority to U.S. Provisional Patent No. 62/295,413 entitled “System And Method For Return-Home Command In Manual Flight Control,” filed Feb. 15, 2016, which is herein incorporated in full by reference for all purposes.

### GOVERNMENT SUPPORT

Not Applicable.

### TECHNICAL FIELD

This application relates to a method and system for controlling the flight of an unmanned aerial vehicle (UAV). In particular, this application relates to ensuring a return-home command is always present when manually providing flight instructions.

### BACKGROUND

A “lost link” may occur when controlling an aircraft manually with a radio. If the radio link between the controller and the aircraft is disrupted, the craft only knows the last command and this may result in a “fly away” and loss of the UAV if the link is not restored.

This background information is provided to reveal information believed by the applicant to be of possible relevance to the present invention. No admission is necessarily intended, nor should be construed, that any of the preceding information constitutes prior art against the present invention.

### SUMMARY

The system and method disclosed herein protects a UAV from lost link issues. A flight plan is uploaded to the UAV with a return-to-home (RTH) command that it will always execute, irrespectively of whether the plan is modified by remote control instructions during the flight, or whether the communications link from the controller to the UAV is broken. The UAV may be flown manually, without a flight plan, but the RTH command will still be present and followed if the link is lost.

Disclosed herein is a method for controlling an unmanned aerial vehicle (UAV) comprising: storing, by a processor in the UAV, an RTH command in a memory in the UAV; receiving a flight instruction from a manually operated remote controller that has radio contact with the UAV; flying the UAV under control of a flight controller module in the UAV, the flight controller executing said instruction; and when said radio contact is lost while the UAV is following said instruction, further flying the UAV under control of the flight controller, which executes the RTH command with said radio contact still lost.

The radio contact may be lost due to one or more of: radio interference; insufficient battery power in the remote controller; failure of the remote controller; switching off of the remote controller; failure of one or more components used to enable the radio contact; and insufficient strength of transmitted signals between the remote controller and the UAV.

In some embodiments, the RTH command instructs the UAV to return to a location from where it took off.

In some embodiments, the RTH command is stored in the UAV during manufacture of the UAV. In some embodiments, the RTH command is executed immediately upon said loss of radio contact. In some embodiments, the RTH command is executed after a predetermined time delay following said loss of radio contact. In some embodiments, the RTH command is executed when a charge level of one or more batteries in the UAV has fallen below a cut-off value. In some embodiments, the cut-off value is predetermined. In some embodiments, the cut-off value is calculated to be above an amount sufficient for the UAV to complete the RTH command, based on a current location of the UAV and a home location corresponding to the RTH command.

In some embodiments, method further comprises, prior to the flight controller executing said flight instruction, flying the UAV according to a flight plan stored in the memory; and interrupting flight of the UAV according to said plan to execute said instruction.

In some embodiments, the UAV resumes the flight plan immediately upon said loss of radio contact; after a predetermined time delay following said loss of radio contact; or when a charge level of one or more batteries in the UAV has fallen below a cut-off value, the cut-off value being calculated to be above an amount sufficient for the UAV to complete the flight plan.

In some embodiments, the UAV resumes the flight plan from where the flight plan was interrupted or from a point on the flight plan nearest to a current location of the UAV upon loss of radio contact.

In some embodiments, the flight instruction is one or more of an instruction to hover; an instruction to move to a location entered on the remote controller; an instruction to follow a modified flight plan that is transmitted from the remote controller to the UAV; an instruction to observe an object of interest; or an instruction to track an object of interest.

In some embodiments, the location entered on the remote controller is a default location; a location selected from a group of predetermined locations; or a location identified on a map displayed on the remote controller.

In some embodiments, the location identified on the map is identified by the selection of: a volumetric space in relation to the map; or a box overlaid on the map and an elevation.

In some embodiments the method further comprises updating a home location corresponding to the RTH command while said radio contact is available.

In some embodiments, wherein said radio contact is lost due to radio interference, the method further comprises recording a location where said radio contact was lost in the flight controller; and uploading said location to a server that records locations of radio interference that cause radio contact loss to other UAVs.

In some embodiments, the method further comprises prior to storing said RTH command, prompting a user of the UAV to enter a home location for the RTH command on the remote controller.

Also disclosed herein is an unmanned aerial vehicle (UAV) comprising: a memory; a processor configured to store an RTH command in the memory; and a flight controller module configured to control flight of the UAV by executing a flight instruction received from a manually operated remote controller that has radio contact with the UAV; wherein, when said radio contact is lost while the UAV is following said instruction, the flight controller is further configured to control flight of the UAV by executing the RTH command while said radio contact is still lost.

Still further disclosed is a computer-readable medium comprising computer-readable instructions which, when executed by a processor in an unmanned aerial vehicle (UAV) cause the processor to: store an RTH command in a memory in the UAV; receive a flight instruction from a manually operated remote controller that has radio contact with the UAV; instruct a flight controller in the UAV to fly the UAV according to said instruction; and when said radio contact is lost while the UAV is following said instruction, instruct the flight controller to execute the RTH command while said radio contact is still lost.

### BRIEF DESCRIPTION OF DRAWINGS

The following drawings illustrate embodiments of the invention, which should not be construed as restricting the scope of the invention in any way.

FIG. 1 is a schematic representation of a system for providing an RTH command to a UAV, according to an embodiment of the present invention.

FIG. 2 is a schematic representation of a UAV showing some of its components, according to an embodiment of the present invention.

FIG. 3 is a flowchart of a process undertaken to control a UAV, according to an embodiment of the present invention.

FIG. 4 is a schematic representation of a process that a UAV undergoes, according to an embodiment of the present invention.

FIG. 5 is a schematic representation of a further process that a UAV undergoes, according to an embodiment of the present invention.

FIG. 6 is a schematic representation of a process that a UAV undergoes to log regions of radio interference, according to an embodiment of the present invention.

### DESCRIPTION

### Glossary

The term “controller” or “remote controller” refers to the electronic user-computing device that a user uses to remotely control a UAV in real time.

The term “firmware” includes, but is not limited to, program code, microcode, logic and data used to control and manage the interactions between the various modules of the system.

The term “flight controller module” refers to an electronic control module located on a UAV, which is used for controlling the motors of the UAV, and may be referred to as “the flight controller” herein.

The term “fly away” refers to a UAV which loses contact with the remote controller that is being used to control it, and as a result of loss of control continues to fly in the last direction it was commanded to fly in, often away from the operator.

The term “hardware” includes, but is not limited to, the physical housing for a computer as well as the display screen, connectors, wiring, circuit boards having processor and memory units, power supply, and other electrical components. It also includes physical components of a UAV.

The term “module” can refer to any component in this invention and to any or all of the features of the invention without limitation. A module may be a software, firmware or hardware module, and may be located in the UAV, a user device or a server.

LOI—Line of interest.

The term “lost link” refers to the disruption of a radio control communications path (radio contact) between a remote controller and an aircraft such as a UAV that is being controlled by the controller.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

The term “object of interest” (OOI) refers to a real-world, physical feature that is to be observed by a camera or a sensor on an aerial vehicle. An OOI may be a point of interest (POI), such as a power line pylon, a radio tower, a tree, etc. It may also be a line of interest (LOI), such as a straight wall or a straight pipeline. It may also be a curve of interest (COI), such as a coast line, a curved wall or a curved pipeline. An OOI is visible on a map displayed by the system.

POI—Point of interest.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, that are ultimately grounded in physical processors.

The term “software” includes, but is not limited to, program code that performs the computations necessary for calculating and optimizing user inputs, controlling the UAV, the reporting and analysis of UAV specific data, displaying information, and, managing of input and output data.

The term “system” when used herein refers to a system for providing RTH commands to UAVs, the system being the subject of the present invention.

### EXEMPLARY EMBODIMENT

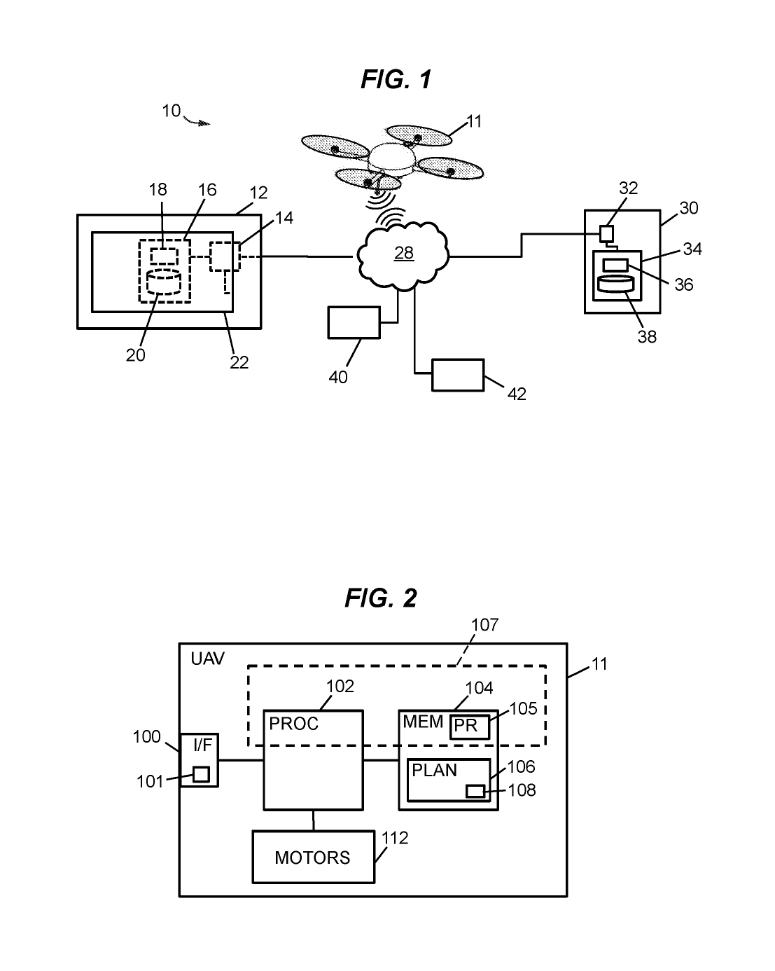

Referring to FIG. 1, shown is an exemplary system 10 for providing return-home flight commands to a UAV 11. The representative system 10 includes or interacts with a user-computing device 12, which may be a laptop or desktop computer, for example, or any other electronic device that provides the necessary equivalent functionality to fulfill the requirements of the invention without limitation. The user device 12 includes one or more processors 14 which are operably connected to computer readable memory 16 included in the device. The system 10 includes computer readable instructions 18 (e.g. an application) stored in the memory 16 and computer readable data 20, also stored in the memory. The memory 16 may be divided into one or more constituent memories, of the same or different types. The user device 12 includes a display screen 22, operably connected to the processor(s) 14. The display screen 22 may be a traditional screen, a touch screen, a projector, an electronic ink display or any other technological device for displaying information. The user device 12 is used to upload flight plans and other commands to the UAV 11 before and/or after the UAV takes off. The user device 12 can be connected either wirelessly or via a wired connection to the UAV 11. The user device 12 is also used as a remote controller for the UAV 11.

A multi-rotor UAV, such as UAV 11, typically has multiple rotors and one motor per rotor supported by an airframe (or body), which also holds a flight controller, battery, and one electronic speed controller (ESC) per motor. Attached to the airframe is one arm per motor, which in this example amounts to a total of four arms. The battery is connected to each ESC, which in turn controls the amount of power supplied to each motor respectively. The flight controller module sends instructions to each ESC instructing it on the amount of power each motor should receive. Such an instruction may be, for example, a number corresponding to the required revolutions per minute (RPM). The flight controller in the multi-rotor UAV in FIG. 1 sends messages to four ESCs, where each ESC is paired with one motor to control the speed of it. By manipulating the speed of each motor the flight controller can command the UAV to hover and move.

The user device 12 is connected to or into the system via a network 28, which may, for example, be the internet, a telecommunications network, a local area network, a bespoke network or any combination of the foregoing. Communications paths in the network 28 may include any type of point-to-point or broadcast system or systems. The UAV 11 is connected to the network 28 wirelessly (e.g. via Zigbee™) and optionally via a wired connection. Other users or even the same user may have further user devices 40, 42 with functionally equivalent components to those of device 12, which may also be part of, or connected to, the system. User devices 40, 42 may be portable or non-portable computing terminals.

The system 10 may also include a server 30, which has one or more processors 32 operably connected to a computer readable memory 34, which stores computer readable instructions 36 and computer readable data 38. Data 38 may be stored in a relational database, for example. The server 30 may be wirelessly or wiredly connected to the network 28 and may include one or more reference and administrative databases for updating software, providing map locations, providing image analysis, and so forth.

Referring to FIG. 2, various electronic and software components of the UAV 11 are shown, including a communications interface 100, one or more processors 102, one or more physical memories 104, a flight control program 105 stored in the memory, a flight plan 106 stored in the memory and an RTH command 108 stored in the memory as part of the flight plan. The communications interface 100 provides a link, which is wired and/or wireless, to the network 28. The interface 100 may also link directly to the user device 12 for uploading flight plans to it and/or other commands. The processor 102 stores in the memory 104 the flight plans 106 and modified flight plans that are received via the interface 100. The processor 102 executes the instructions in flight control program 105 to retrieve the flight plan 106, in order to control the motors 112 of the UAV 11. The processor 102 and flight control program 105 can be considered to be, or form part of, the flight controller module 107. The processor 102 also executes the manual instructions received via the communications interface 100. The interface may include multiple constituent interfaces, each using a different technology, and may include a radio signal strength sensor 101

Some or all of the computer readable instructions 18, 36, 105 and computer readable data 20, 38, 106 provide the functionality of the system 10 when executed or read by one or more of the processors 14, 32, 102. Computer readable instructions may be broken down into blocks of code or modules.

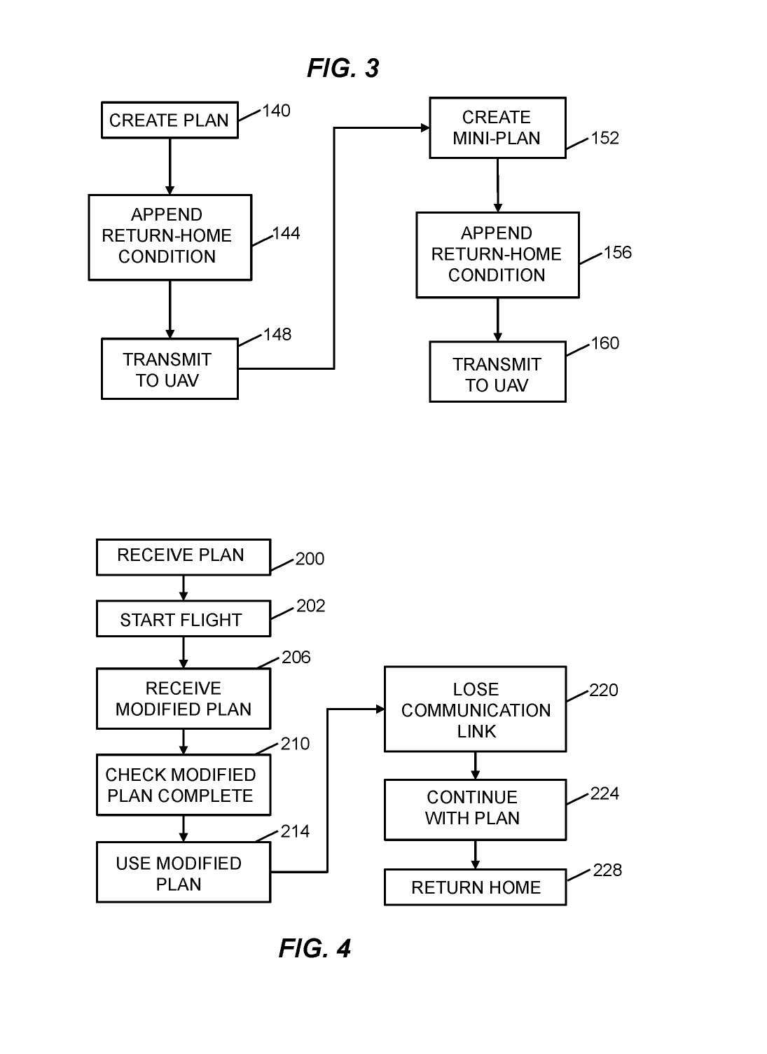

Referring to FIG. 3, a flowchart is shown that is followed when a user is setting up a flight plan. In step 140, the user creates a flight plan 106, using, for example the user-computing device 12, with or without the assistance of server 30.

In step 144, the user either includes an RTH command in the plan or appends an RTH command to it. The RTH command is the last command of the flight plan. The system 10 may be configured to automatically add the return-to-home command to the flight plan, and it may use either the current location or the starting location of the UAV as the default home location to which the RTH command will direct the UAV. In other embodiments, the user may be requested or prompted to enter a return-home location, or to select from a list of one or more predefined locations.

In step 148, the flight plan is transmitted to the UAV 11. The flight plan 106 may be uploaded to the UAV 11 either by a wired connection or a wireless connection. The processor 102 in the UAV stores the RTH command 108 in the memory 104 in the UAV.

In step 152, which would typically occur while the UAV is flying according to the flight plan that has been uploaded, the user creates a “mini plan”. The mini plan may be a pause in the initial flight plan, a modification to the current flight plan, or it may be a manual control instruction that is to interrupt the flight plan currently being executed.

In step 156, the user optionally appends an RTH command to the mini plan. If the location to which the UAV is to return home to is unchanged, then there is no need to append a new return-home location. If the return-home location is to be changed, then a new home location can be specified by the user, or selected from a set of one or more predefined locations.

In step 160, the mini plan is transmitted to the UAV 11, wirelessly because the UAV is in flight. The user may transmit the mini plan from user device 12, for example, or from device 40 or 42.

Referring to FIG. 4, a flowchart of a process is shown that the UAV 11 performs when using the invention. In step 200, the UAV receives an initial flight plan via an upload from either the user-computing device 12 or the server 30. In step 202, the UAV takes off, following the flight plan that has been uploaded to it. In step 206, the UAV receives a modification to the flight plan, for example in the form of a mini plan. If the modification is in the form of a mini plan, then it may be a manual control that has been input by the user. If the modification to the flight plan is more extensive, then it may be a significant or complete overriding of the remainder of the existing flight plan. In other cases, the modification to the flight plan may be merely an instruction to pause or to hover, or to move to another location and hover, or to track an object, for example. The UAV receives the modified flight plan via an upload from either the user-computing device 12 or the server 30. In step 210 the UAV determines whether the uploaded modification to the flight plan is complete. The plan data is created with error checking codes, so that the UAV can verify that it has received the entire plan. This applies both to the original flight plan and the modification to the flight plan.

In step 214, the UAV switches its flight path from following the original flight plan to following the modified flight plan. In step 220, as happens from time to time, the UAV loses radio contact with the user-computing device 12 (or other device 30, 40 or 42) from which it is receiving modifications to its flight plan. In step 224, the UAV continues with the modified flight plan without radio contact with the user-computing device 12 (or remote controller). If radio contact is once again made between the controller and the UAV, then further modifications to the flight plan can be made, otherwise, the UAV continues with the flight plan to its end, returning home in step 228.

One benefit of the invention is that an uploaded flight plan can be interrupted at any time with another, modified plan without loss of the return-to-home executable and associated condition or conditions. The flight control software as executed by the flight control module can work like a manual controller by issuing mini plans while the original plan is interrupted. As the mini plans always have a return home condition or conditions, or a condition to revert to the original plan, or they never override the return-home step of the originally uploaded plan, the craft will always have an operational plan to come home even if it suffers a lost link. This may be known as Positive Link™ technology.

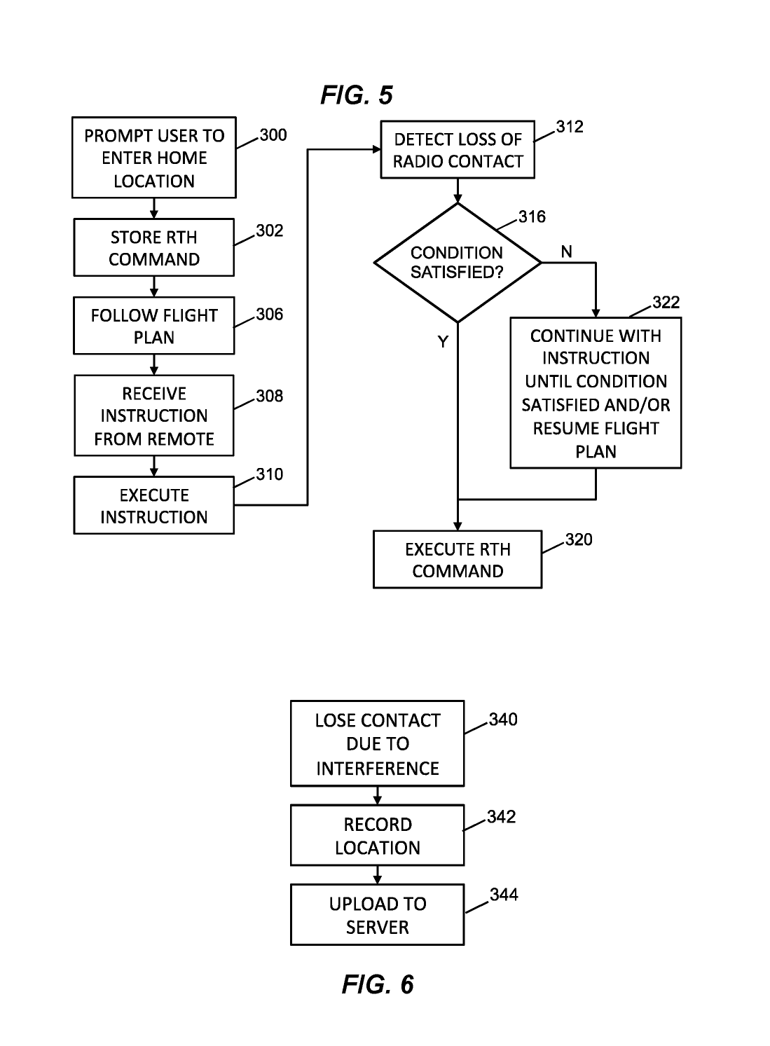

Referring to FIG. 5, in step 300 the user is prompted to enter a home location into the user device 12 (i.e. a remote controller). This step is optional, as the home location may be defined by default to be whatever location of the UAV takes off from. In step 302, if a home location is entered by the user, the processor 102 in the UAV 11 stores the home location in the memory 104 as part of the RTH command. In other embodiments, the RTH command may be stored in memory during manufacture of the UAV, with the home location being whatever the take off location is. In step 306, the flight plan that has been uploaded to the UAV 11 is followed by the UAV, as it flies under control of the flight controller. In some embodiments this is optional, as the UAV may be being flown entirely under control of the remote controller.

In step 308, the processor 102 in the UAV 11 receives an instruction that has been transmitted to it from the remote controller. The instruction may be a real-time instruction that corresponds to manipulation of manual controls on the remote controller. Alternately, the instruction may be to follow a modified flight plan that is transmitted to the UAV from the remote controller, while the UAV is in flight or is otherwise following the flight plan. It is envisaged that part of the flight plan may include the UAV landing temporarily. In step 312, the UAV detects loss of radio contact with the remote controller. Sensing circuitry in the communications interface 100 may detect the strength and/or presence of a radio signal received from the remote controller, or a sensor in the interface in conjunction with programming code in the memory executed by the processor may act as a radio sensor.

In step 316, in response to the radio contact being lost, the processor determines whether a condition is satisfied that would warrant the UAV executing the RTH command. For example, the condition may be the passage of a predetermined time delay after detecting loss of radio contact, or a decline in battery level to a point that is just safely adequate to compete fly the UAV to its home location. If the condition is satisfied, the UAV is flown home by its execution of the RTH command, in step 320. If the condition is not satisfied in step 316, then the UAV continues in step 322 with the instruction or instructions received from the remote controller. Optionally, the UAV resumes the flight plan in step 322, either from where it left it or from its nearest point to the current location of the UAV. When the condition to implement the RTH command is satisfied, after continuing with the instruction or at the end of the UAVs flight plan, the RTH command is executed in step 320.

FIG. 6 refers to the logging of locations that are subject to loss of radio contact due to interference. In step 340, the UAV loses radio contact with its remote controller due to interference. In step 342, the UAV records its location at the time that radio contact was lost. In step 344, the location where the radio contact was lost is uploaded to the server 30, either when the UAV regains radio contact, when the UAV is later connected to the network 28 via the user device 12 (remote controller), or from the user device 12 at a later time.

### Variations

It is possible to use the system 10 in conjunction with citizen mapping. For example, a map of the world is shown, with locations and/or areas where radio contact has been lost. The UAV and/or controller would record the locations where radio contact has been disrupted, and these locations would be uploaded to the map (e.g. on server 30) after radio contact is made again. Such areas may indicate to other users of UAVs that there is a risk of interference that disrupts radio signals. As more and more people use the UAVs and record zones of radio signal loss, the map is filled in. The system can then be used to monetize the data for the owners of the data by selling subscriptions, for example. In another embodiment, a time slider could be used to animate maps that change. Known methods for providing a reward and/or incentive to a user based on the value of the user's data could be employed, for example, methods such as those described in U.S. Pat. No. 8,862,497, entitled “Method and system of determining and issuing user incentives on a web server via assessment of user-generated content relevance and value”.

In some embodiments a further mode can be incorporated into the flight control software and user interface. This mode is based upon a point and click navigation approach. While the UAV 11 is in flight, the user clicks on a location on the map on the screen 22 and the UAV moves to the newly clicked point and then hovers there. This mode is a hybrid between planning and executing. For example, the software shows the progression of the actual, real-time flight path as it is occurring. However if a new point is double clicked, or otherwise entered as a system command, during the flight, then the UAV 11 processes the command. To do this, it first makes sure that it is a complete command via a checksum, and then overrides the last command. If the UAV 11 is hovering, then it goes to the newly requested location. Whenever radio contact is lost between the controller and the UAV, whether the UAV is following the original flight plan or a modification to the flight plan, the flight software can display on the screen 22 an estimated location of the UAV, by assuming that it is continuing with the flight plan or modified flight plan that it has received.

A point-of-interest (POI) or line-of-interest (LOI) could also be specified in this point and click navigation mode. For example, if a POI is specified, the UAV 11 focuses its camera on the POI as it moves to the new navigation point (or waypoint). Optionally, lines are displayed on a user interface (UI) on screen 22 in order to indicate the focus of the camera. For example, the current position of the UAV is joined to the POI, and the new navigation point and the POI are joined by a line. The UI may also display a representation of the UAV 11 and animate its movement from its current location to the new navigation point, simultaneously updating the line connecting the UAV and the POI/ LOI. There is also a height slider to control the altitude of the UAV in this mode.

The point and click navigation system may be adapted to perform object tracking if certain hardware is made available to the software. For example, a laser range finder is included in the available hardware to provide the range from the UAV 11 to a point on the map/earth where the camera or sensor has focus. The UAV system has a live video or thermal video feed directly piped into the UI. In one embodiment, an “x” on the center of the UI in the live video feed represents the center of focus of the camera or sensor, and at the same time the system knows the distance from the UAV to the center of focus via the laser range finder. If the user then clicks on the UI on a different object (e.g. a person in the live view), the system calculates the distance from the UAV to that object. If the hardware has access to the frame by frame image data obtained by the camera/sensor, then it can recognize pixels rapidly changing and/or pixels with a different signature in the center of focus, which can be used for object tracking. A thermal camera is better suited for tracking thermal objects because the thermal pixel value differential is large and the typically lower resolution of the sensors compared to visible light cameras allows for faster calculation of the pixels that change. Knowing the geometry (i.e. location of tracked object, location of UAV, altitude of UAV, distance between the tracked object and the UAV etc.) allows the system to calculate a path as the object moves, which may be fed back into the UI and the navigation system. The UAV can then follow the path to track the object, and adjust its flight as the path changes in real time. Note that a range finder built into a typical camera has very limited range and would not be as effective as a dedicated laser range finder.

In some embodiments a pause function can be included when flying a mission. During the mission, the UAV 11 can be paused at whatever point it is in its flight path, in which case it transitions into a loiter state. During the loiter state a display pops up on screen 22 that allows the user to modify the UAV's position and camera, and to resume the mission at any time. The UAV's position can be modified in real time, with a click of a button to position on the map a square box, for example, that describes a default 10 m×10 m box. The resulting real-time UAV control is based on telling the UAV its final position, the movement to which is executed in real time at a default speed. This is unlike other controls that would move the UAV 11 based on a directional command. An elevation slider or an absolute position widget can be used for elevation, for example. The default size and shape represented by the positional control is a volumetric space of 10 m×10 m×10 m and can be modified to other dimensions and/or shapes in the settings, as well as the default speed for moving the UAV to such a position. Depending on the settings, the original mission may either be resumed from the point it was paused at, or from the nearest point on the original flight path to the present location of the UAV. If radio contact between the controller and the UAV is broken during a pause command, such as when the UAV is hovering, then, depending on the embodiment, the UAV, as controlled by the flight control module, will resume the stored flight plan immediately, after a predetermined delay, or when the battery charge remaining is the minimum amount left in order to fly home safely.

The system may have a procedure that uses default criteria as well as user modified criteria for determining a lost link, and a default behavior as well as a user defined behavior for recovery from a lost link. For example, one set of criteria may include the conditions: (a) no communication for at least 5 seconds between the UAV and the remote control; (b) enough battery power to complete the original mission; and (c) the UAV has stable flight; and upon all of these conditions occurring together the UAV would return to its original mission. The criteria and associate behaviors could be quite complex, and many different variations are possible.

Another example is that while flying the craft manually, if the operator switches off the remote radio controller, the UAV will automatically default to the RTH command, as switching off the remote controller would be equivalent to breaking the radio communication link.

In some embodiments, there are no user steps required to ensure the presence of the RTH command during manual flight, even though it is expected that the user may fly the UAV without first uploading a flight plan. In these embodiments, the UAV flight controller is pre-configured prior to shipment with the RTH command(s). So, if during a flight, the UAV flight controller detects no radio signal, then the RTH command is initiated. Since the radio signal is always transmitting, regardless of the remote controller's switch positions, a loss of signal will meet the RTH criterion and the RTH command will be executed on the UAV by the flight controller.

In regards to another remote controller taking control of a UAV, this is theoretically possible but very unlikely. If a customer, such as a governmental entity, had a specific request, then it would be possible to add encryption to the Controller/Receiver ID (i.e. common identification number of the remote controller and the UAV's receiver). This would prevent the UAV from an unintended interruption in its flight plan or manual control due to a command transmitted from a remote controller with the same ID, which, however, is unlikely. It would also protect the flight controller from an intended hacking scenario.

Although the present invention has been illustrated principally in relation to UAVs it also has wide application in respect of other autonomous vehicles such as rovers.

In general, unless otherwise indicated, singular elements may be in the plural and vice versa with no loss of generality. The use of the masculine can refer to masculine, feminine or both.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety for all purposes. Relevant patent applications include U.S. patent application Ser. No. 15/236,716, titled “Autonomous System for Unmanned Aerial Vehicle Landing, Charging and Takeoff”, filed 2016 Aug. 15; Ser. No. 15/390,222, titled Rotor Arm Assembly and Fitting for Unmanned Aerial Vehicle, filed 2016 Dec. 23; and, Ser. No. 15/401,056, titled “Camera Angle Visualization for Aerial Vehicle Flight Plan”, filed 2017 Jan. 8.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. Flowcharts from different figures may be combined in different ways. All parameters, dimensions and configurations described herein are examples only and actual values of such depend on the specific embodiment. Accordingly, the scope of the invention is to be construed in accordance with the substance defined by the eventual claims.

We claim:

1. A method for controlling an unmanned aerial vehicle (UAV) configured with an on-board processor with flight controller module, memory, supporting circuitry, and at least one battery, comprising:
storing a return-to-home command (RTH) in the memory, wherein the processor is configured to execute the return-to-home command in a period during which radio contact is lost, the RTH command defining a home location for the UAV;
receiving, by the processor, a flight instruction, wherein the instruction is received from a manually operated remote controller in operative radio contact with the UAV;
executing, by the flight controller, said flight instruction;
detecting a loss in radio contact while the UAV is following said instruction; and,
executing the RTH command by flying the UAV under control of the flight controller to the home location designated in the RTH command.

2. The method according to claim 1, comprising defining the home for the UAV as the location from which flight was initiated.

3. The method according to claim 1, further comprising:
storing a flight plan in the memory and immediately prior to receiving said instruction, flying the UAV according to the flight plan.

4. The method according to claim 1, comprising executing the RTH command immediately in the condition that radio contact is lost.

5. The method according to claim 1, comprising executing the RTH command after a predetermined time delay in the condition that radio contact is lost.

6. The method according to claim 1, wherein the RTH command is executed when a battery charge level has fallen below a cut-off value.

7. The method according to claim 6, wherein the cut-off value is predetermined.

8. The method according to claim 7, wherein the cut-off value is calculated to be above the battery charge level that is sufficient for the UAV to complete the RTH command, based on a current location of the UAV and the home location defined in the RTH command.

9. The method according to claim 1, comprising executing the RTH command in the condition that:
radio interference prevents radio control;
battery power in the remote controller is insufficient to remain in radio contact;
the remote controller fails;
the remote controller is switched off;
one or more components used to enable radio contact fails;
signals between the remote controller and the UAV have insufficient strength for retaining radio contact; or
a combination of any of the above conditions.

10. The method according to claim 1, comprising storing the RTH command as a firmware or a software feature during or after manufacture of the UAV.

11. The method according to claim 3, comprising resuming execution of the flight plan in memory in the condition that radio contact is lost, wherein said flight plan is resumed:
immediately upon said loss of radio contact;
after a predetermined time delay following said loss of radio contact; or
when a charge level of one or more batteries in the UAV has fallen below a cut-off value, wherein the cut-off value is calculated to be above the battery charge level that is sufficient for the UAV to complete the RTH command, based on a current location of the UAV and the home location defined in the RTH command.

12. The method according to claim 11, comprising resuming the flight plan in memory under control of the flight controller:
from where the flight plan was interrupted; or
from a point on the flight plan nearest to a current location of the UAV.

13. The method of claim 1, wherein the instruction comprises a step for:
hovering;
flying to a location entered on the remote controller;
following a modified flight plan that is transmitted from the remote controller to the UAV;
observing an object of interest under control of flight controller; or,
an instruction to track an object of interest under control of the flight controller.

14. The method of claim 13, wherein the location entered on the remote controller is:
a default location;
a home location;
a location selected from a group of predetermined locations; or,
a location identified on a map displayed on the remote controller.

15. The method of claim 14, wherein the location identified on the map is identified by the selection of:
a volumetric space in relation to the map; or,
a box overlaid on the map and an elevation.

16. The method of claim 1, further comprising updating the home location defined in the RTH command during any period in which radio contact is available.

17. The method of claim 1, wherein said radio contact is lost due to radio interference, the method further comprising:
recording a location where said radio contact was lost; and
uploading said location to a server that records locations of radio interference that cause radio contact loss to other UAVs.

18. The method of claim 1, wherein said radio contact is lost due to radio interference, insufficient battery power in the remote controller, failure of the remote controller; switching off of the remote controller, failure of one or more components used to enable the radio contact, and insufficient strength of transmitted signals between the remote controller and the UAV; the method further comprising
recording a location where radio contact was lost,
evaluating an alternate flight plan in memory and any RTH command options,
selecting an option from:
a) proceed to an alternate location;
b) proceed home;
c) hover; or,
d) land safely.

19. The method of claim 1, further comprising prompting a user of the UAV to enter a home location for the RTH command on the remote controller before initiating a flight.

20. An unmanned aerial vehicle (UAV) comprising:
a memory;
a processor with flight controller module and flight instruction set, wherein said instruction set is configured to store a routine for controlling flight and a routine for executing a return-to-home (RTH) command in said memory;
wherein said flight controller module is configured to control flight of the UAV by a) executing a flight plan, a mini plan, or instructions received from a manually operated remote controller that has radio contact with the UAV and b) by executing the RTH command from said memory if radio contact with said manually operated remote controller is lost;
a radio sensor configured to detect a loss in radio contact between said UAV and said manually operated remote controller and report such loss in radio contact to said processor; and,
executable instructions in said memory for executing the RTH command according to one or more conditions.

21. The unmanned aerial vehicle (UAV) of claim 20, wherein the flight controller is configured to fly the UAV according to any combination of:
local control from the manually operated remote controller;
automatic control according to the RTH command when radio contact with said manually operated remote controller is lost;
automatic control to track a moving object;
automatic control that directs flight to an object of interest (OOI), a point of interest (POI) or a line of interest (LOI); or,
autonomous flight control.

22. A computer-readable medium comprising computer-readable instructions which, when executed by a processor in an unmanned aerial vehicle (UAV) cause the processor to:
store a return-to-home (RTH) command in a memory in the UAV;
receive an instruction from a manually operated remote controller that has radio contact with the UAV;
instruct a flight controller in the UAV to fly the UAV according to said instruction; and,
when said radio contact is lost while the UAV is following said instruction, instruct the flight controller to execute the RTH command while said radio contact is still lost.
